(19) United States
(12) Patent Application Publication
(10) Pub. No.: US 2005/0072521 A1
(43) Pub. Date: Apr. 7, 2005

(54) Sealing a gasketed juncture

(75) Inventor: Tae-Kyung Kim, Sterling Heights, MI (US)

Correspondence Address: EATON CORPORATION;EATON CENTER, 1111 SUPERIOR AVENUE, CLEVELAND, OH, 44114, US

(73) Assignee: EATON CORPORATION, Cleveland, OH (US)

(21) Appl. No.: 10/679,659

(22) Filed: Oct. 6, 2003

(51) Int. Cl. B29C 65/00

(52) U.S. Cl. 156/295; 264/261

(57) ABSTRACT

A method of ensuring sealing between edges of adjacent compression gaskets utilizes a recess in the edge of one gasket with a projection on a second gasket extending partially into the recess to form a pocket. A measured amount of curable sealant is placed in the pocket and the gasketed joint assembled compressing the gaskets and the sealant causing the sealant to fill the pocket. Upon curing, the sealant ensures a seal between the edges of the adjacent gaskets.

### BACKGROUND OF THE INVENTION

The present invention relates to gasketing between structural members and particularly relates to gasketing of the parts of an internal combustion engine where, for example, a gasket is provided between the juncture of the cylinder head and the engine cylinder block and a separate gasket is provided for sealing between the juncture of an intake manifold with the cylinder block.

Heretofore, where mutual edge contact sealing of the different gaskets is required for the assembly of the engine, it has been found particularly difficult to provide an effective seal between the gaskets, particularly where the gaskets are of different thicknesses or formed of different material. For example, the gaskets may be formed of elastomeric materials of different stiffness or compressibility and thus it is virtually impossible to provide sufficient dimensional control to the gaskets during their manufacture such that upon installation and compression the adjacent edges are insured of sealing contact. Thus, it has long been desired to provide a way or means of insuring sealing between the edges of adjacent individual gaskets employed for sealing between structural members, and particularly for sealing between gaskets in an engine.

### BRIEF SUMMARY OF THE INVENTION

The present invention provides a unique method of sealing adjacent edges of gaskets employed for sealing between structural members as, for example, parts of an engine where it is required to seal between the edges of the adjacent gaskets. The method of the present invention includes configuring or forming the adjacent edges of the gaskets to create a pocket therebetween. A measured amount of a curable sealant is deposited in the pocket upon installation of the gaskets on the corresponding surfaces of the structural members to be gasketed. Upon installation of the remaining structural members and compression of the gaskets, the curable sealant is dispersed to fill the pocket. Subsequently the curable sealant is cured by ambient curing, irradiating or elevated temperature curing. The cured sealant thus insures a positive seal between the edges of the adjacent gaskets.

### BRIEF DESCRIPTION OF THE DRAWINGS

FIG. 1 is a perspective view of a pocket formed between the edges of adjacent individual gaskets placed upon a structural member with a measured amount of uncured sealant disposed in the pocket; and,

FIG. 2 is a view similar to FIG. 1 showing a second structural member in place compressing the gaskets and disbursing the sealant in the pocket to seal the edges of the gaskets.

### DETAILED DESCRIPTION OF THE INVENTION

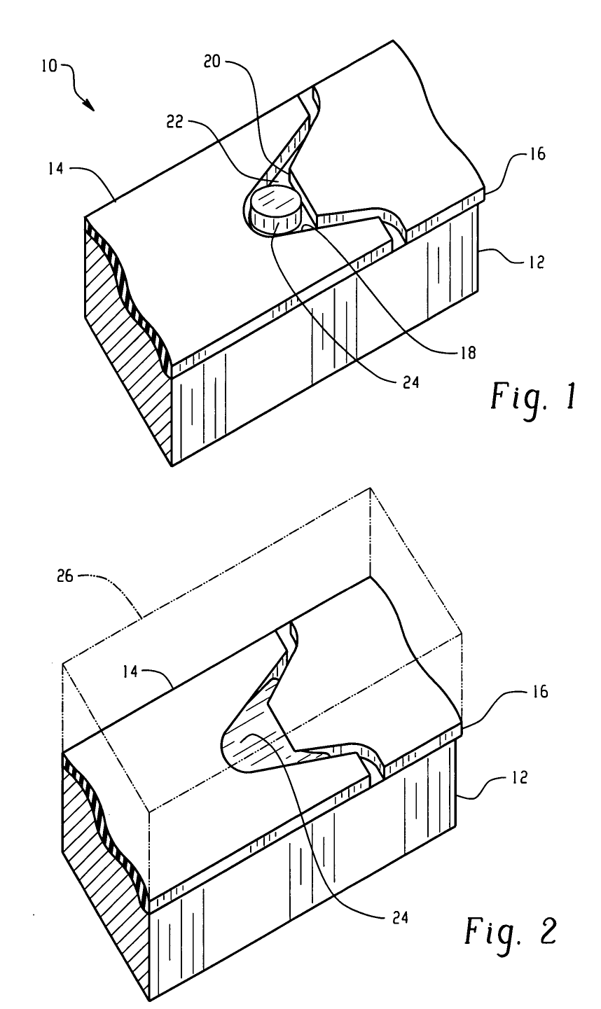

Referring to FIG. 1, the invention is illustrated as embodied in a gasketed joint and indicated generally at 10 and includes a first structural member or base 12 to be joined with at least one other member (not shown in FIG. 1) in a gasketed joint and has disposed on the surface thereof a first gasket 14 for sealing between member 12 and an unshown member. A second gasket 16 is disposed on the surface of member 12 or the edge thereof spaced from gasket 14 for sealing between member 12 and an unshown structural member. One edge of gasket 14 is configured in a generally V-shaped configuration as denoted by reference numeral 18; and, the corresponding spaced adjacent edge of gasket 16 is configured with a tapered truncated projection 20 which has a portion thereof extending into the recess 18. The recess 18 and the projection 20 are configured so as to form a pocket or void 22 therebetween into which is disposed a measured amount of uncured sealant as denoted by reference numeral 24.

In the present practice of the invention the uncured sealant 24 may be in the form of a preformed pellet or may be dispensed as a drop of gel from a dispenser.

In the presently preferred practice of the invention the sealant 24 comprises a curable silicone elastomer gel material which may be curable at ambient or room temperatures. Alternatively the uncured sealant may be of the type requiring heating or elevated temperatures to effect curing thereof. Another alternative manner of curing the sealant 24 is that of irradiation as, for example, by microwave emission. It will be understood that the material of the sealant is chosen to be compatible with that of the material of the gaskets 14, 16. In the present practice sealant 24 is preferably of an elastomeric material having a stiffness or compressibility significantly less than that of either of the gaskets 14, 16.

The technique of the present invention for sealing between the edges of gaskets 14, 16 is particularly advantageous in arrangements where the materials of the gaskets 14, 16 are substantially different, as for example, where one is a cylinder head gasket for an engine and the other comprises an intake manifold or combustion chamber valve deactivation manifold assembly gasket.

Referring to FIG. 2, the invention is shown in the fully assembled state wherein a second structural member 26, shown in dashed outline, is received over the surfaces of gaskets 14, 16 and is joined to member 12 by suitable fasteners (not shown). In the condition shown in FIG. 2 the gaskets 14, 16 are compressed and the sealant 24 is dispersed and fills the pocket 22 and extends into the narrow channels between the edges of the recess 18 and the projection 20. The sealant 24 is thus dispersed into the condition shown in FIG. 2 prior to curing. Upon sufficient curing the sealant thus secures the seal between the edges of the gasket 14 and the gasket 16.

Although the invention has hereinabove been described with respect to the illustrated embodiments, it will be understood that the invention is capable of modification and variation and is limited only by the following claims.

1. A method of sealing a gasketed joint comprising:
(a) disposing a first gasket on a surface of a first member to be sealed;
(b) disposing a second gasket on said surface adjacent an edge of said first gasket;
(c) forming a pocket between an edge of said second gasket and said edge of said first gasket;
(d) disposing a measured amount of curable sealant in said pocket;
(e) disposing a surface of a second member to be sealed over said first and second gasket and compressing said gaskets and dispersing said sealant and filling said pocket; and,
(f) curing said sealant.

2. The method defined in claim 1, wherein said step of disposing a measured amount of sealant includes disposing a pellet of uncured elastomer.

3. The method defined in claim 1, wherein said step of disposing includes applying said sealant in semi-liquid form.

4. The method defined in claim 1, wherein said step of disposing curable sealant includes disposing a silicone gel.

5. The method defined in claim 1, wherein said step of curing said sealant includes one of (i) ambient temperature curing, (ii) elevated temperature curing (iii) irradiating.

6. The method defined in claim 1, wherein said step of forming a pocket includes forming a “V” shaped cavity.

7. The method defined in claim 6, wherein said step of dispersing includes flowing sealant into narrow side channels of said “V” shape.

8. The method defined in claim 1, wherein said step of disposing a first and second gasket includes disposing a gasket of material significantly stiffer in compression than said cured sealant.
